(19) United States
(12) Patent Application Publication
(10) Pub. No.: US 2006/0238177 A1
(43) Pub. Date: Oct. 26, 2006

(54) Apparatus for power control in lighting systems

(76) Inventors: Giuseppe Tagliati, Via Costarella (IT); Gianfranco Pistelli, Viale Bismantoya (IT)

Correspondence Address: PEARNE & GORDON LLP, 1801 EAST 9TH STREET, SUITE 1200, CLEVELAND, OH, 44114-3108, US

(21) Appl. No.: 10/546,643

(22) PCT Filed: Feb. 27, 2003
(86) PCT No.: PCT/IT03/00109

§ 371 Date: May 15, 2006

(51) Int. Cl. G05F 1/14

(52) U.S. Cl. 323/255

(57) ABSTRACT

Apparatus for power control, in particular for lighting installations, provided with an autotransformer (11), to be connected to a supply unit (20) to draw a predetermined voltage therefrom, and with a first transformer (30) having a first winding (31) connected to the autotransformer (11) and through which a control current (310) runs, and a second winding (32) to be connected to a load (40) to control the power delivered to the latter. The apparatus (1) further comprises a control unit (50), to regulate the control current (310) depending on the predetermined voltage; the control unit (50) comprises a connecting block (60) drivable between a first operating condition at which it directly connects a first end (31a) of the first winding (31) to a first auxiliary terminal (12a) of the autotransformer (11), a second operating condition at which it connects the first end (31a) of the first winding (31) to a second auxiliary terminal (12b) of the autotransformer (11) through a first resistor (111), and at least one third operating condition at which it directly connects the first end (31a) of the first winding (31) to the second auxiliary terminal (12b).

The present invention relates to an apparatus for power control, in particular for lighting systems.

It is known that different typologies of electric installations, lighting systems in particular, require control of the power delivered to the loads connected therewith, for the purpose of both minimizing consumptions and maximising the useful lifetime of the loads themselves that due to an excessive power absorbed over too long periods of time can give rise to failures or malfunctions.

By way of example, lighting installations for streets are to be considered: early in the morning or early in the evening a full-power operation of the installation is not necessary, since visibility is partly allowed by the first light present at dawn and the light still present at sunset; on the other hand, control of the power absorbed by the lamps or other lighting devices enables the latter to prolong their useful lifetime.

Known control systems involve use of autotransformers through which selection of a predetermined portion of the supply voltage takes place, which portion is then subtracted to the voltage that is transferred to the load.

This portion of the supply voltage can be varied by suitably selecting the output terminals of the autotransformer, and selectively connecting them with a transformer associated with the load, so that the voltage to be sent to the load itself is varied in accordance with the desired amount.

Said selection of the terminals to be connected is carried out through a series of switches or relays each of which is connected with a respective terminal, and a control card operatively active on the switches to suitably regulate the output voltage to be supplied.

A drawback present in the installations of known type consists in that, as the voltage applied to the load must be varied, when the latter is connected to the control system, power failures on the load and/or transient short-circuits in the connected or cut-out sections through activation of the different switches may occur.

In fact, a variation in the voltage delivered to the load is typically obtained through change of the autotransformer terminal connected with said transformer disposed in series with the load; this variation essentially consists in opening the switch associated with the connected terminal and closing a switch associated with a different terminal.

During performance of the above described operations, due to the practical impossibility of carrying them out without delays and in a perfectly simultaneous manner, two cases may substantially occur: either the first switch is opened before the second is closed (then a power failure on the load takes place) or the second switch is closed before the first switch has been opened (thus causing a short-circuit on the autotransformer thereby impairing a correct operation of same).

Accordingly, the present invention aims at solving the above mentioned drawbacks.

More particularly, it is an aim of the present invention to provide an apparatus for power control, in particular for lighting installations enabling the voltage on the load to be varied when said voltage is connected with the latter, without causing power failures on the load or a short-circuit between the autotransformer portions.

It is an additional aim of the present invention to provide an apparatus for power control enabling the consumptions of the installation with which it is connected to be reduced while at the same time limiting wear of the circuit components of the installations themselves.

The foregoing and further aims are substantially achieved by an apparatus for power control, in particular for lighting installations, in accordance with the features described in the appended claims.

Further features and advantages will become more apparent from the detailed description of a preferred embodiment of an apparatus for power control, in particular for lighting installations illustrated by way of non-limiting example in the accompanying drawings, in which:

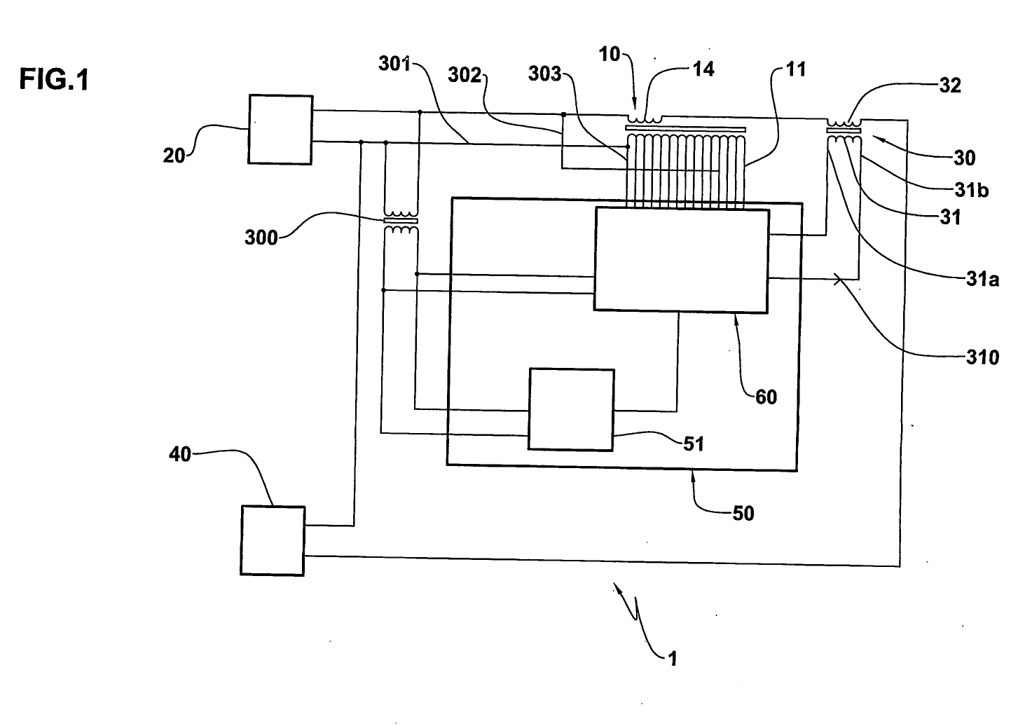

FIG. 1 is a schematic diagram of the apparatus in accordance with the present invention;

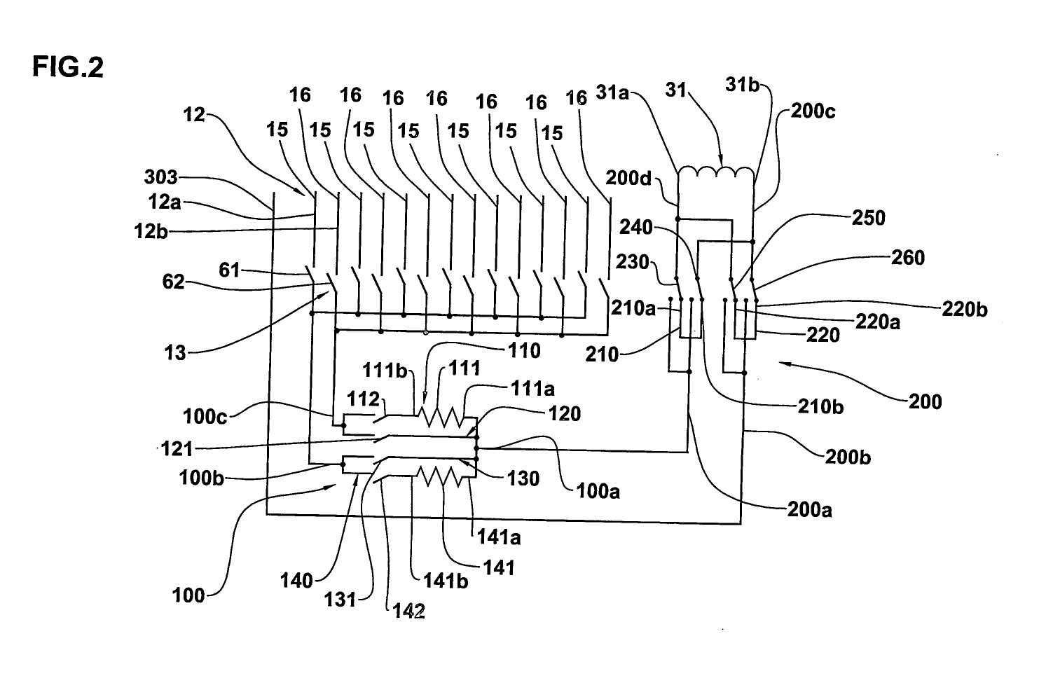

FIGS. 2-12 diagrammatically show different operating conditions of the apparatus in FIG. 1.

The apparatus for power control in accordance with the present invention is generally identified by reference numeral 1 in the accompanying figures.

Referring particularly to FIG. 1, apparatus 1 first of all comprises an autotransformer 11 to be connected with a supply unit 20 to draw a predetermined voltage therefrom; typically, the supply unit 20 will be a supply mains with which apparatus 1 is connected.

Autotransformer 11 has a first and a second inputs 301 and 302 connected to said power mains.

In the case of single-phase supply, the first input 301 is connected to the “neutral” of the supply unit 20, whereas the second input 302 is connected to the “phase”.

In the case of three-phase supply without neutral, the first and second inputs 301, 302 will be connected with the terminals corresponding to two different phases, respectively; it is apparent that, for correct regulation of the power outputted from apparatus 1, use of an autotransformer for each pair of terminals (phase 1-phase 2; phase 2-phase 3; phase 3-phase 1) of the supply unit 20 will be required, together with the circuitry associated with such an autotransformer.

In the case of three-phase supply with neutral, the first input 301 is connected to the neutral of the supply unit 20, whereas the second input 302 is connected with one of the phases; in this case too, for an efficient regulation use of three autotransformers is provided, each of them being associated with a respective control circuit: each autotransformer therefore will have an input connected with the mains neutral, whereas the other input will be connected with one of the phases (each autotransformer will be obviously associated with a different phase).

The following description refers to a single autotransformer and to the control circuit combined therewith; in the light of the above, it is apparent how extension to the case with several phases can be carried out.

The autotransformer 11 is provided with a main terminal 303 to be used, as better clarified in the following, to supply the downstream-connected circuitry with the voltage drawn from the supply unit 20; this main terminal 303 practically is defined by an extension of the first input 301 and is therefore connected to the neutral or to one phase of the supply unit 20 in accordance with the above description.

The autotransformer 11 further has a plurality of auxiliary terminals 12 (FIG. 2), each associated with a respective switch 13, through which portions of the autotransformer 11 having different lengths (that is number of coils) can be selected; in this way, depending on the number of the switches that are closed and therefore of the terminals connected with the rest of the circuit, a predetermined voltage having a given proportionality ratio with the voltage drawn through inputs 301, 302 can be obtained.

In particular, the predetermined voltage is outputted from autotransformer 11 through said main terminal 303 and the auxiliary terminal 12 selected through the respective switch 13.

Conveniently, the auxiliary terminals 12 are divided into a first group 15 and a second group 16 and the auxiliary terminals of the first group 15 and the second group 16 are disposed in an alternate sequence; in other words, each of the auxiliary terminals of the first group 15, possibly with the exception of those positioned at the ends of autotransformer 11, is included between two auxiliary terminals of the second group 16; likewise, each of the auxiliary terminals of the second group 15, possibly with the exception of those positioned at the ends of autotransformer 11, is included between two auxiliary terminals of the first group 15.

Utility of such a division together with the connections relating to each group 15, 16 will be better clarified later on.

Apparatus 1 is further provided with a first transformer 30, associated with autotransformer 11 to control the outputted power.

In more detail, the first transformer 30 has a first winding 31 connected to autotransformer 11 and a second winding 32 operatively coupled with the first winding 31 and connected with a load 40; a control current 310 runs through the first winding 31 and, depending on said current, regulation of the power delivered to load 40 is carried out.

Practically, the first winding 31 defines the “primary” of the first transformer 30, whereas the second winding 32 defines the “secondary” of the first transformer 30 itself.

In a preferred embodiment, the second winding 32 of the first transformer 30 is connected in series with the load 40, so that the voltage reaching load 40 corresponds to the voltage drawn from autotransformer 11 less the voltage drop on the second winding 32 of the first transformer 30.

It is to be noted that, depending on the connections to be described in the following, the voltage drop on the second winding 32 of the first transformer 30 can be also added to the mains voltage therefore regulating the voltage reaching load 40 in a different manner.

Autotransformer 11 can be advantageously coupled with an auxiliary winding 14, so as to define a second transformer 10; the auxiliary winding 14 has at least one end connected with the supply unit 20, and is preferably connected in series with the second winding 32 and the load 40.

Autotransformer 11 constitutes the “primary” of the second transformer 10, whereas the auxiliary winding 14 defines the “secondary”.

The voltage drop at the extremities of the auxiliary winding 14 is therefore subtracted from the voltage supplied to load 40, therefore further reducing said voltage.

In order to regulate said control current 310 depending on the predetermined voltage drawn from the supply mains 20, apparatus 1 is equipped with a control unit 50, connected in circuit between the autotransformer 11 and first transformer 30.

The control unit 50 first of all comprises a connecting block 60 in turn consisting of a main connecting circuit 100 and an auxiliary connecting circuit 200.

The main connecting circuit 100 (FIG. 2) has a first end 100a to be connected with a first end 31a of the first winding 31, a second end 100b to be connected with a first auxiliary terminal 12a of autotransformer 11, and a third end 100c to be connected with a second auxiliary terminal 12b of autotransformer 11.

In fact, the connecting block 60 is also equipped with a first main switch 61 and a second main switch 62. The first main switch 61 is drivable between a closed position at which it connects the first auxiliary terminal 12a with the second end 100b of the main connecting circuit 100, and an open condition at which it does not connect the first auxiliary terminal 12a with said second end 100b.

Likewise, the second main switch 62 is drivable between a closed condition at which it connects the second auxiliary terminal 12b with the third end 100c of the main connecting circuit 100 and an open condition at which it does not carry out such a connection.

The first end 100a of the main connecting circuit 100 is connectable with the first end 31a of the first winding 31 through the auxiliary connecting circuit 200 to be better described in the following.

In more detail as regards structure of the main connecting circuit 100, the latter comprises a first branch 110, a second branch 120, a third branch 130 and preferably a fourth branch 140.

The first branch 110 is interposed between the first and third ends 100a, 100c of the main connecting circuit 100; the first branch 110 is substantially defined by a first resistor 111 having a first end 111a connected with the first end 100a of the main connecting circuit 100 and a second end 111b connected with a first switch 112.

The first switch 112 is drivable between a closed condition at which it connects the second end 111b of the first resistor 111 with the third end 100c of the main connecting circuit 100, and an open condition at which it does not carry out such a connection.

The second branch 120 of the main connecting circuit 100 is interposed between the first and third ends 100a, 100c of the main connecting circuit 100 itself; the second branch 120 substantially consists of a second switch 121, drivable between a closed condition at which it connects up the first and third ends 100a, 100c of the main connecting circuit 100 and an open condition at which such a connection does not occur.

The third branch 130 is interposed between the first and second ends 100a, 100b of the main connecting circuit 100; the third branch 130 too is substantially defined by a third switch 131, drivable between a closed condition at which said first and second ends 100a, 100b of the main connecting circuit 100 are connected up, and an open condition at which such a connection does not take place.

The fourth branch 140 is interposed between the first and second ends 100a, 100b of the main connecting circuit 100.

The fourth branch 140 comprises a second resistor 141 having a first end 141a connected to the first end 100a of the main connecting circuit 100 and a second end 141b connected to a fourth switch 142.

The fourth switch 142 is drivable between a closed condition at which it connects the second end 141b of the second resistor 141 to the second end 100b of the main connecting circuit 100 and an open condition at which such a connection does not take place.

As above mentioned, the connecting block 60 is also equipped with an auxiliary connecting circuit 200, operatively associated with the main connecting circuit 100.

In more detail, the auxiliary connecting circuit 200 has a first end 200a connected with the first end 100a of the main connecting circuit 100, a second end 200b connected with the main terminal 303 of the autotransformer 11, a third end 200c connected with a second end 31b of the first winding 31, and a fourth end 200d connected with the first end 31a of the first winding 31 itself.

The inner structure of the auxiliary connecting circuit 200 is preferably made as described herebelow.

First of all a first branch 210 and a second branch 220 are provided, the former having a first and a second ends 210a, 210b and the latter also exhibiting first and second ends 220a, 220b.

In addition, together with said first and second branches 210, 220, four switches are present to obtain different connecting configurations between the ends 31a, 31b of the first winding 31 and the remaining part of apparatus 1.

A first switch 230 is drivable between a first operating condition at which it connects the first and fourth ends 200a, 200d of the auxiliary connecting circuit 200 with one another and a second operating condition at which connection between the fourth end 200d of the auxiliary connecting circuit 200 and the first end 210a of the first branch 210 occurs.

A second switch 240 is drivable between a first operating condition at which it connects the first and third ends 200a, 200c of the auxiliary connecting circuit 200 to one another and a second operating condition at which the third end 200c of the auxiliary connecting circuit 200 is connected with the second end 210b of the first branch 210.

A third switch 250 is drivable between a first operating condition at which the second and fourth ends 200b, 200d of the auxiliary connecting circuit 200 are connected to one another and a second operating condition at which connection takes place between the fourth end 200d of the auxiliary connecting circuit 200 and the first end 220a of the second branch 200.

A fourth switch 260 is drivable between a first operating condition at which it connects the second and third ends 200b, 200c of the auxiliary connecting circuit 200 to one another and a second operating condition at which it connects the third end 200c of the auxiliary connecting circuit 200 with the second end 220b of the second branch 220.

At the beginning, when apparatus 1 is not yet power supplied, the four switches 230, 240, 250, 260 (that can be embodied by conventional relays) are in their second operating condition, as shown in FIG. 2.

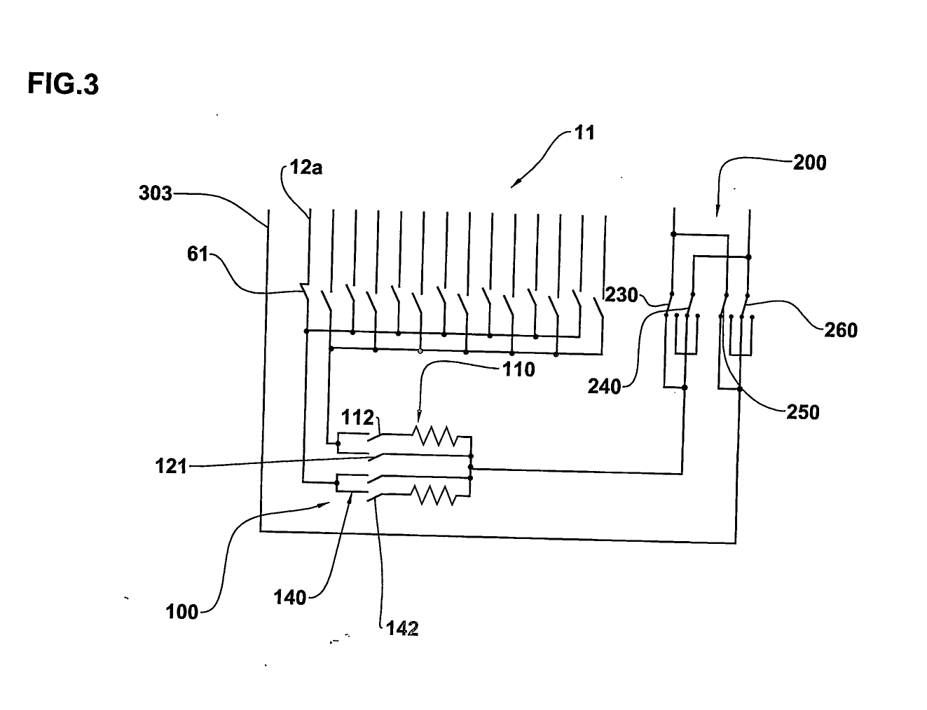

Subsequently, when apparatus 1 is power supplied, said switches 230, 240, 250, 260 must go to their first operating condition (FIG. 3).

Conveniently, transition takes place by exploiting an intermediate configuration: first, the first and second switches 230, 240 are changed over and subsequently changing over of the third and fourth switches 250, 260 takes place.

In this way a direct connection (i.e. a short-circuit) is always ensured between the first and second ends 31a, 31b of the first winding 31, avoiding creation of arcs during said changing over, in particular should the load be already connected to apparatus 1 by mistake.

During these first steps, switches 13 of the connecting block 60 (and, in particular, the first and second main switches 61, 62) and switches 112, 121, 131, 142 of the main connecting circuit 100 are in their open condition.

Even after changing over of switches 230, 240, 250, 260, the ends 31a, 31b of the first winding 31 in the second transformer 30 are short-circuited so that no voltage drop occurs at the extremities of the first winding 31 and the voltage supplied to load 40 is the same as the mains voltage, less the drop at the extremities of the auxiliary winding 14 of the first transformer 30; under this situation the control current 310 is zero.

Subsequently, the first main switch 61 is piloted to its closed condition (FIG. 3), thereby connecting the first auxiliary terminal 12a of autotransformer 11 with the second end 100b of the main connecting circuit 100.

It is apparent that, since all switches 112, 121, 131, 142 of the main connecting circuit 100 are still in their open condition, closure of the first main switch 61 alone at the moment does not cause any substantial variation in the current flows within apparatus 1; in particular, the control current 310 of the first winding 31 is still zero.

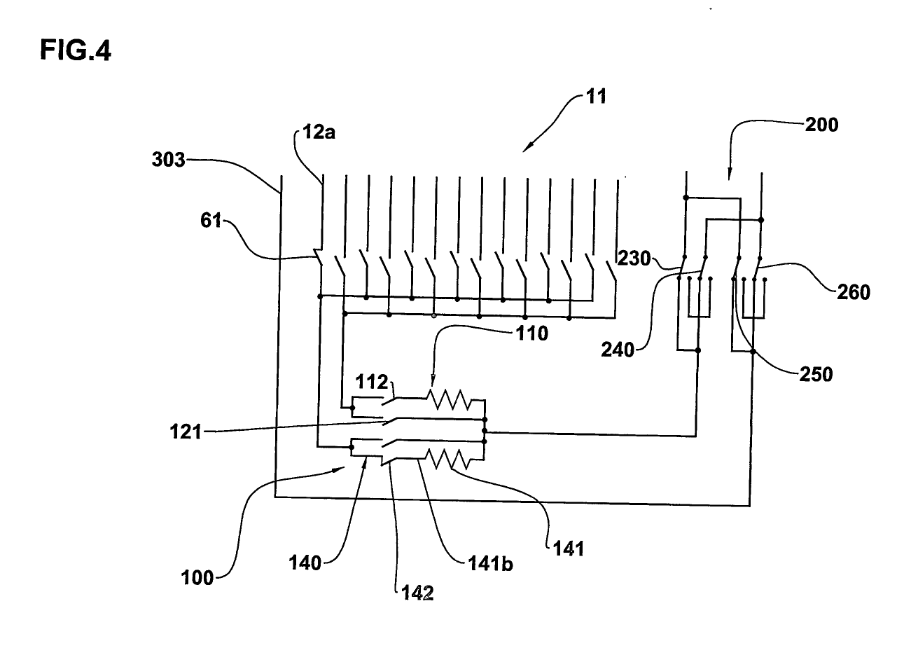

Then the fourth switch 142 of the main connecting circuit 100 (FIG. 4) is closed thereby connecting the second end 100b of the main connecting circuit 100 and the second end 141b of the second resistor 141 to one another; since the first main switch 61 is in its closed condition and the first switch 230 of the auxiliary connecting circuit 200 is in its first operating condition, a connection between the first auxiliary terminal 12a of autotransformer 11 and the first end 31a of the first winding 31 is carried out via the fourth branch 140 of the main connecting circuit 100.

In this case, a predetermined current runs through said second resistor 141 of the main connecting circuit 100; however, since the ends 31a and 31b of the first winding 31 are still short-circuited, again there is no voltage drop at the extremities of the first winding 31; the control current 310 therefore goes on being zero.

Subsequently, the second and third switches 240, 250 of the auxiliary connecting circuit 200 are piloted to their second operating condition (FIG. 5); thus the mesh defined by the first winding 31, the second resistor 141 and the selected portion of autotransformer 11 is closed through switching the first main switch 61 off, i.e. the mesh included between the main terminal 303 and the first auxiliary terminal 12a.

Therefore, a non-zero control current begins running in the first winding 31 and the voltage at the extremities of the first winding 31 itself corresponds to the potential difference between the main terminal 303 and the first auxiliary terminal 12a of autotransformer 11, less the voltage drop on the second resistor 141.

The voltage at the extremities of the first winding 31, as above described, produces a corresponding voltage on the second winding 31 thus varying the voltage delivered to load 40.

To obtain a variation of opposite sign, it is possible to leave the second and third switches 240, 250 of the auxiliary connecting circuit 200 to their first operating condition and move the first and fourth switches 230, 260 of the auxiliary connecting circuit 200 to the second operating condition; in this way, the voltage transferred to the first winding 31 will have the same absolute value but opposite sign. Consequently, the voltage induced on the second winding 32 will have opposite sign with respect to the preceding case, and also the corresponding variation in the voltage supplied to load 40 will have opposite sign.

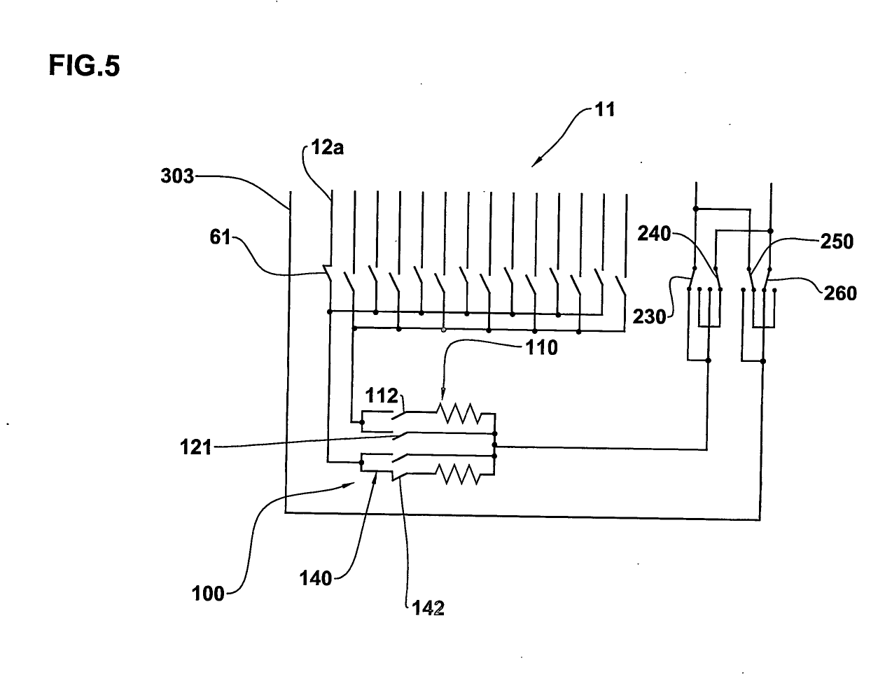

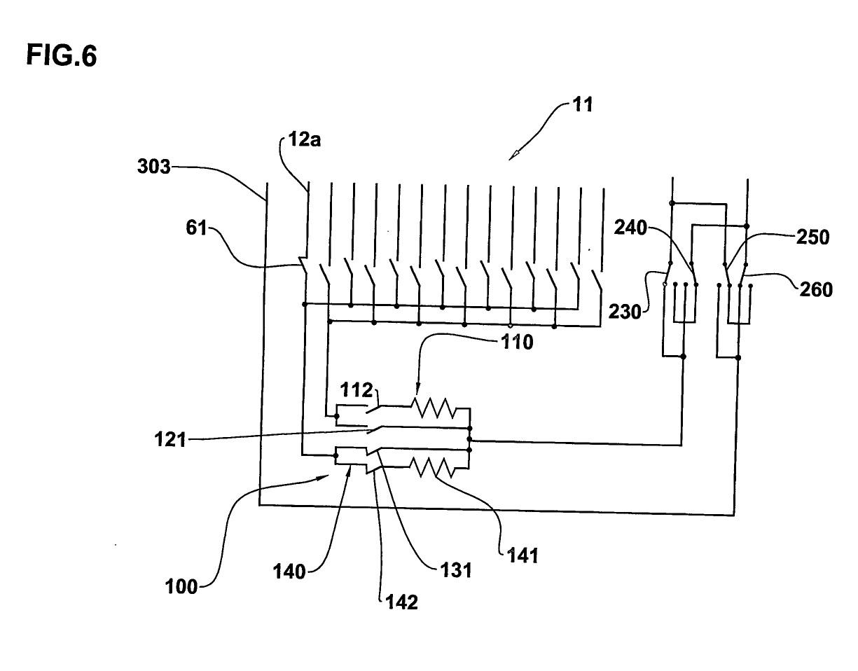

Finally, bringing the third switch 131 of the main connecting circuit 100 to the closed condition (FIG. 6) and the fourth switch 142 of the main connecting circuit 100 to the open condition (FIG. 7), the second resistor 141 is short-circuited and the output voltage of autotransformer 11 is fully transferred to the extremities of the first winding 31, the control current 310 being increased due to the absence of the second resistor 141; thus a first operating condition of the control unit 50 is defined at which the first end 31a of the first winding 31 is directly connected to the first auxiliary terminal 12a.

Therefore the voltage that is transferred to load 40 under this condition is the mains voltage, less the voltage drop at the extremities of the first winding 31 and the voltage drop at the extremities of the auxiliary winding 14.

As above mentioned, the voltage at the extremities of the first winding 31 can also be added to the mains voltage by suitably piloting the second connecting circuit 200.

If the power delivered to load 40 is now wished to be varied, it is necessary that an auxiliary terminal different from the first auxiliary terminal 12a of autotransformer 11 should be selected, so as to correspondingly select a different number of coils on autotransformer 11 and thus draw a different voltage from the supply unit 20, to be transferred to the first winding 31.

In carrying out this change, as above said, the greatest attention is to be paid to different aspects: power failures at load 40 must not take place (in case of lighting installations, these failures even if almost imperceptible, can create non negligible problems, above all if they occur with some frequency) and short-circuits between the terminals of autotransformer 11 must be clearly avoided.

Said problems arise due to the practical impossibility of carrying out changing over of the different switches in a perfectly simultaneous and instantaneous manner and, in particular, of the first and second main switches 61, 62.

Therefore, apparatus 1 is provided with the above described connecting block 60 that is employed as hereinafter illustrated, in order to avoid the above mentioned drawbacks.

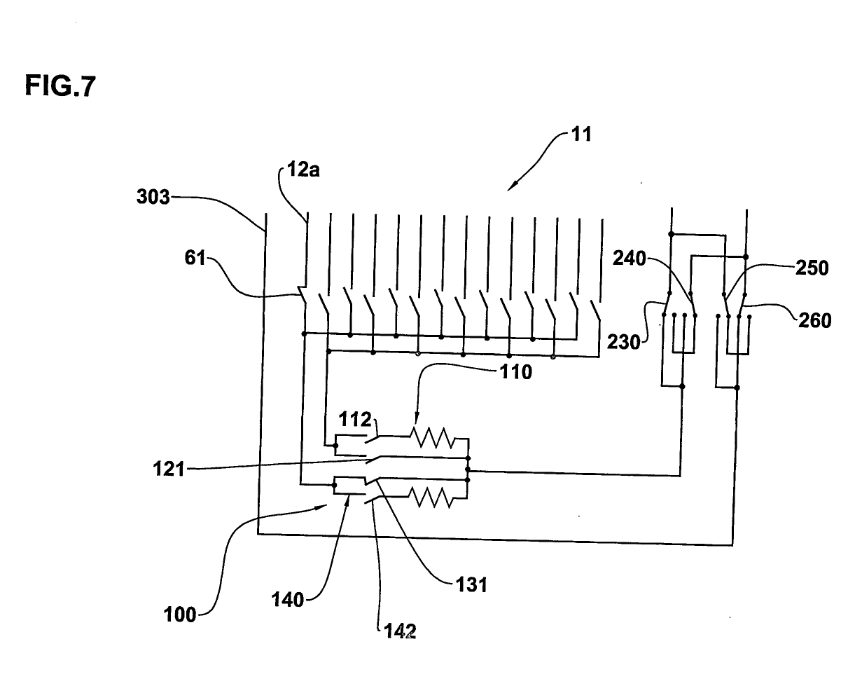

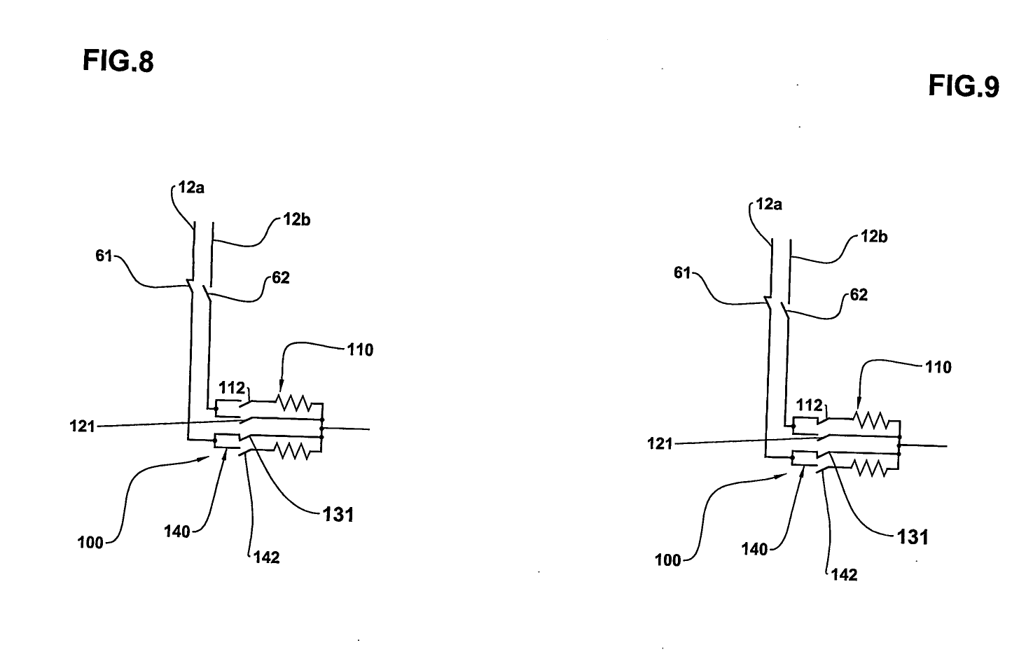

In order to pass from the first operating condition of the control unit 50, at which the first auxiliary terminal 12a of autotransformer 11 is connected with the first end 31a of the first winding 31, to a second operating condition at which it is the second auxiliary terminal 12b of autotransformer 11 that is connected to this first end 31a, first of all the second main switch 62 is piloted to its closed condition (FIG. 8). In this way, the second auxiliary terminal 12b is connected with the third end 100c of the main connecting circuit 100.

However, since both the first and second switches 112, 121 of the main connecting circuit 100 are in their open condition, closure of the second main switch 62 alone at the moment does not cause any effect in the operation of apparatus 1.

It is to be noted that in FIGS. 8-12 only part of apparatus 1 is shown, i.e. that part submitted to the necessary variations for the described regulation; the remaining portion of apparatus 1 is intended of a configuration as shown in FIG. 7.

Subsequently, the first switch 112 of the main connecting circuit 100 is closed (FIG. 9); in this way a current begins running between the first and second auxiliary terminals 12a, 12b of autotransformer 11, said current being limited by the first resistor 111.

The situation shown in FIG. 9 is defined as a first intermediate operating condition of the control unit 50, whereas FIG. 8 represents a second intermediate operating condition of the unit 50 itself.

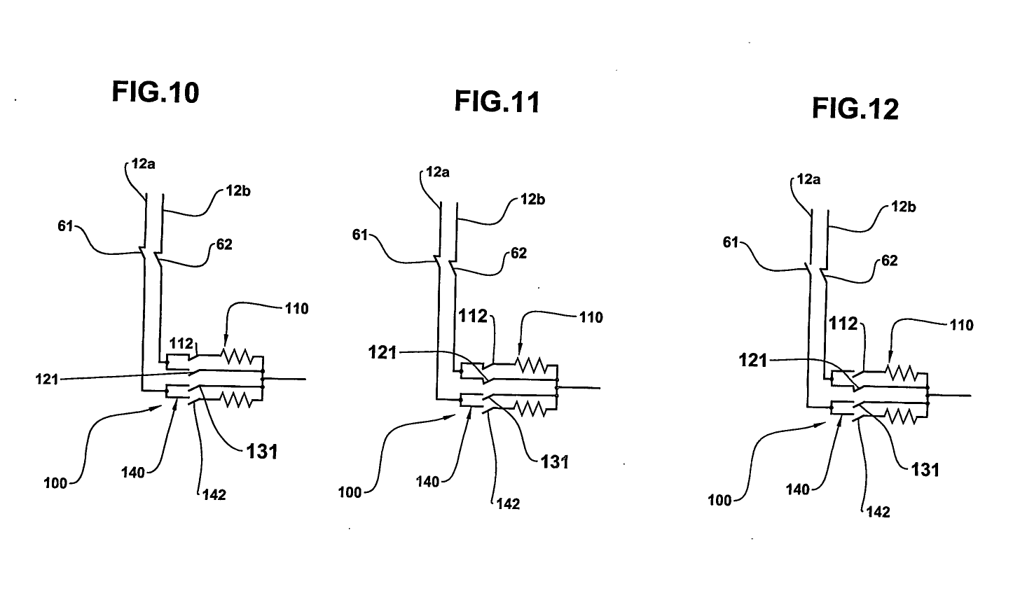

Then the third switch 131 is brought to the open condition (FIG. 10), so that the first auxiliary terminal 12a is cut out and connection between the first end 11a of the first resistor 111 and the first auxiliary terminal 12a is prevented, as well as connection between the first end 31a of the first winding 31 and the same first auxiliary terminal 12a; the control current 310 now fully runs in the first branch 110 and the voltage delivered by autotransformer 11 is divided between the first resistor 111 and the first winding 31, that are connected in series with each other (second operating condition of the control unit 50).

Subsequently, the first resistor 111 is short-circuited through the second branch 120 closing the second switch 121 (FIG. 12); the control current 310 now runs in the second branch 120 alone, defining a third intermediate operating condition of the control unit 50.

The last operation to be executed is that of opening the first main switch 61 and the first switch 112 of the main connecting circuit 100 (FIG. 12), since the connections defined by them are of no utility in operation of apparatus 1 (third operating condition of the control unit 50).

It is to be appreciated that, through use of apparatus 1 following the above described modalities, the power delivered to load 40 can be varied without interrupting power supply thereto; in fact by virtue of the appropriate operation of the utilized switches, the first and second ends 31a, 31 of the first winding 31 are always connected to a closed circuit.

In other words, the first winding 31, since it is always part of a closed mesh, never allows the second winding 32 to stop the current flow intended for load 40.

In addition, it is important to note that the first and second auxiliary terminals 12a, 12b belong to said plurality of auxiliary terminals 12 of autotransformer 11; in more detail, the first auxiliary terminal 12a belongs to the first group 15, whereas the second auxiliary terminal 12b belongs to the second group 16. In fact, as shown in FIG. 2 for example, the auxiliary terminals of the first group 15 (and the first auxiliary terminal 12a therewith) can be connected, by means of the respective switches, to the second end 100b of the main connecting circuit 100, whereas the auxiliary terminals of the second group 16 (and the second auxiliary terminal 12b therewith) can be connected, by means of the respective switches, to the third end 100c of the main connecting circuit 100.

In this way, by creating substantially independent conductive paths between the auxiliary terminals of the first group 15 and the first end 31a of the first winding 31 and between the auxiliary terminals of the second group 15 and said first end 31a of the first winding 31, the above described changing over operations can be carried out.

In addition, the alternate arrangement of the auxiliary terminals of the first and second groups 15, 16 enables gradual variations in the power delivered to load 40 to be carried out, thereby contributing to maximise the useful lifetime of the load 40 itself, above all should apparatus 1 be designed for power regulation in a lighting installation and should load 40 be defined by one or more lamps.

It is clear that the above described operation, in connection with transition between the first and second auxiliary terminals 12a, 12b, can be carried out substantially in the same manner between any pair of adjacent auxiliary terminals, until the desired voltage is reached.

In more detail, by selecting, through subsequent steps, an auxiliary terminal 12 that is rather far from the main terminal 303, a greater number of coils will be selected in autotransformer 11 and a higher voltage will be drawn from the supply unit 20; this voltage will be then transferred to the first winding 31 and therefrom, to the second winding 32, following a predetermined transformation ratio, so that the voltage delivered to load 40 is reduced (or increased) by an important amount.

Vice versa, by selecting an auxiliary terminal 12 which is rather close to the main terminal 303, less voltage will be drawn and therefore the variation produced to the voltage on load 40, will be smaller.

It is to be noted that all or some of the above mentioned switches (switches 13 associated with the auxiliary terminals 12 of autotransformer 11, switches 112, 121, 131, 142 of the main connecting circuit 100, switches 230, 240, 250, 260 of the auxiliary connecting circuit 200) can be embodied by conventional relays.

Conveniently, the control unit 50 is further provided with a processing block 51, practically made as a microcontroller having the task of controlling operation of the connecting block 60 and, in particular of the first and second main switches 61, 62 (and generally of all switches 13), of the main connecting circuit 100 and the auxiliary connecting circuit 200.

In a preferred embodiment, the processing block 51 and the connecting block 60 are powered by the supply unit 20 through a transformer 300 (FIG. 1).

In the particular case of apparatus 1 being associated with a lighting installation, the processing block 51 could be programmed so as to regulate operation of said circuit elements depending on detecting signals received by an appropriate brightness sensor, so as to modulate the power delivered to the installation depending on the light intensity detected at the outside.

In addition, in combination with or as an alternative to the control carried out depending on the information received from the photoelectric cell, it is possible to set the processing block 51 in such a manner that the power delivered to load 40 follows preestablished cycles having daily or weekly frequencies, for example.

In fact, the processing block 51 can be equipped with an appropriate memory that will contain said operating cycles.

Also stored in said memory can be the different alarms detected during operation of apparatus 1; in fact the processing block 51 can be associated with a predetermined number of sensors capable of monitoring operation of apparatus 1 and generating alarm signals in case of failures or malfunctions.

At each alarm, all information relating to said alarm can be stored: for example detection hours, failure typology, failure-signalling sensor, etc.

The data stored in said memory can be displayed through an appropriate display which is operatively associated with microcontroller 51.

In particular, a voltage detector is positioned at the extremities of the first winding 31 of the first transformer 30: should this voltage exceed a predetermined threshold (which is a clear indication of a malfunction in apparatus 1), the processing block 51 would carry out activation of a bypass condition, in which apparatus 1 is substantially made non-operating and load 40 is fed to full power; should also the auxiliary winding 14 be used, the voltage delivered to load 40 will be defined by the mains voltage less the voltage drop at the extremities of the auxiliary winding 14 itself.

In this way, in case of failure of apparatus 1, load 40 is in any case power supplied, so that further trouble or problems are avoided.

Advantageously, apparatus 1 is also provided with a further protection system, of the mechanical or electro-mechanical type (e.g. obtained by means of a disconnecting switch or a remote control switch) capable of inhibiting operation of the apparatus 1 itself, in particular in case of short-circuits and/or defects in manufacture of the different components.

If, in addition to load 40, other loads are connected downstream of apparatus 1, the processing block 51 could be such programmed that activation of these auxiliary loads is suitably controlled.

For example, in the situation in which a reduced power is delivered to load 40 (i.e. apparatus 1 is performing its regulation task) and a second load is to be activated (another lamp, for example), the processing block 51 stops limitation of the delivered output power for a predetermined time gap, 5-10 minutes for example, so that all the required energy for activation can reach the second load.

Subsequently, upon termination of the switching-on step of the second load, the power limitation is resumed following the set programs.

Advantageously, it is also provided that the processing block 51 may be connected through a telematic network (through a modem or Ethernet, for example), to remote computerized stations, so that operation of apparatus 1 can be monitored and/or set also by operators that are not close to the apparatus 1 itself.

In addition, due to connection to the mains of several loads 40 and/or several apparatus 1, programs for energy saving can be controlled in a centralized manner in cooperation or in coordination with the supplying body.

The invention achieves important advantages.

First of all, through the above described apparatus it is possible to carry out variations in the power delivered to the load, when the latter is connected to the apparatus itself, without interrupting power supply to the load or without short-circuits taking place between the different portions of the circuit that are connected or cut out through operation of the switches.

In particular, due to the resistors employed in the main connecting circuit, short-circuits are avoided between the different auxiliary terminals of the autotransformer.

In addition, since sharp variations in the power delivered to the load are avoided, the likelihood that failures or malfunctions may occur to the load is reduced and therefore the useful lifetime of the load itself is increased.

Furthermore, in the particular case of application to lighting installations, due to the gradual variation of the power delivered to the lamps and to the absence of power interruptions, a continuous and optimal lighting of the concerned area is allowed.

1-19. (canceled)

20. An apparatus for power control, in particular for lighting installations, comprising:
an autotransformer (11) to be connected to a supply unit (20) to draw a predetermined voltage from said supply unit (20) and provided with a main terminal (303) and a predetermined number of auxiliary terminals (12a, 12b), said predetermined voltage being defined between said main terminal (303) and at least one of said auxiliary terminals (12a, 12b);
a first transformer (30), provided with a first winding (31), connected to said autotransformer (11) and through which a control current (310) runs, and a second winding (32) operatively coupled with said first winding (31) and suitable for connection with a load (40) to control the power delivered to the latter;
a control unit (50) interposed in circuit between said autotransformer (11) and said first transformer (30) to regulate said control current (310) depending on said predetermined voltage,
wherein said control unit (50) comprises a connecting block (60) drivable between a first operating condition, at which it directly connects a first end (31a) of said first winding (31) of the first transformer (30) with a first auxiliary terminal (12a) of said autotransformer (11), a second operating condition at which it connects said first end (31a) of the first winding (31) to a second auxiliary terminal (12b) of said autotransformer (11) through a first resistor (111), and at least one third operating condition at which it directly connects said first end (31a) of the first winding (31) with said second auxiliary terminal (12b).

21. An apparatus as claimed in claim 20, wherein said connecting block (60) is also drivable in a first intermediate condition at which it directly connects said first end (31a) of the first winding (31) with said first auxiliary terminal (12a) and connects said first end (31a) with said second auxiliary terminal (12b) through said first resistor (111).

22. An apparatus as claimed in claim 20, wherein said connecting block comprises a main connecting circuit (100) having a first end (100a) connectable to the first end (31a) of said first winding (31), a second end (100b) connectable to said first auxiliary terminal (12a), and a third end (100c) connectable to said second auxiliary terminal (12b).

23. An apparatus as claimed in claim 22 wherein said connecting block (60) further comprises:
a first main switch (61) drivable between a closed condition at which it connects said first auxiliary terminal (12a) to said second end (100b) of said main connecting circuit (100), and an open condition at which it does not connect said first auxiliary terminal (12a) to the second end (100b) of said main connecting circuit (100);
a second main switch (62), drivable between a closed condition at which it connects said second auxiliary terminal (12b) to said third end (100c) of said main connecting circuit (100) and an open condition at which it does not connect said second auxiliary terminal (12b) to the third end (100c) of said main connecting circuit (100).

24. An apparatus as claimed in claim 22, wherein said main connecting circuit (100) comprises:
a first branch (110) interposed between said first and third ends (100a, 100c) of said main connecting circuit (100) and provided with said first resistor (111), the latter having a first end (111a) connected to the first end (100a) of said main connecting circuit (100) and a second end (111b), said first branch (110) being further provided with a first switch (112) drivable between a closed condition at which it connects the second end (111b) of said first resistor (111) with the third end (100c) of said main connecting circuit (100), and an open condition at which it does not connect said ends (111b, 100c);
a second branch (120) interposed between said first and third ends (100a, 100c) of said main connecting circuit (100) and provided with a second switch (121) drivable between a closed condition at which it connects the first and third ends (100a, 100c) of said main connecting circuit (100) and an open condition at which it does not establish said connection;
a third branch (130) interposed between said first and second ends (100a, 100b) of said main connecting circuit (100) and provided with a third switch (131), drivable between a closed condition at which it connects said first and second ends (100a, 100b) of the main connecting circuit (100), and an open condition at which it does not establish said connection.

25. An apparatus as claimed in claim 24 wherein said main connecting circuit (100) further comprises a fourth branch (140) interposed between said first and second ends (100a, 100b) of said main connecting circuit (100) and provided with a second resistor (141), the latter having a first end (141a) connected to said first end (100a) of the main connecting circuit (100) and a second end (141b), said fourth branch (140) being further provided with a fourth switch (142) drivable between a closed condition at which it connects the second end (141b) of said second resistor (141) to the second end (100b) of said main connecting circuit (100) and an open condition at which such a connection is not established.

26. An apparatus as claimed in claim 25, wherein the first operating condition of said connecting block (60) is defined by the closed condition of said first main switch (61) and of the third switch (131) of said main connecting circuit (100), said second operating condition of said connecting block (60) being defined by the closed condition of said first main switch (61), said second main switch (62) and the first switch (112) of said main connecting circuit (100).

27. An apparatus as claimed in claim 25, wherein the third operating condition of said connecting block (60) is defined by the closed condition of said second main switch (62) and of the second switch (121) of said main connecting circuit (100), said first intermediate condition being defined by the closed condition of said first main switch (61), said second main switch (62) and the first and third switches (112, 131) of said main connecting circuit (100).

28. An apparatus as claimed in claim 25, wherein said connecting block (60) is further drivable to a second intermediate condition defined by the closed condition of said first main switch (61), of said second main switch (62) and of the third switch (131) of said main connecting circuit (100), said connecting block (60) being further drivable to a third intermediate condition defined by the closed condition of said second main switch (62), and of the first and second switches (112, 121) of said main connecting circuit (100).

29. An apparatus as claimed in claim 20, wherein said connecting block (60) further comprises an auxiliary connecting circuit (200), interposed between said main connecting circuit (100) and said first transformer (30), said auxiliary connecting circuit (200) having:
a first end (200a) connected to said first end (100a) of said main connecting circuit (100);
a second end (200b) connected to the main terminal (303) of said autotransformer (11);
a third end (200c) connected to a second end (31b) of the first winding (31) of said first transformer (30);
a fourth end (200d) connected to said first end (31a) of said first winding (31).

30. An apparatus as claimed in claim 28, wherein said auxiliary connecting circuit (200) comprises:
a first branch (210) having a first end (210a) and a second end (210b);
a second branch (220) having a first end (220a) and a second end (220b);
a first switch (230) drivable between a first operating condition at which it connects the first and fourth ends (200a, 200d) of said auxiliary connecting circuit (200) with each other, and a second operating condition at which it connects the fourth end (200d) of said auxiliary connecting circuit (200) with the first end (210a) of said first branch (210);
a second switch (240) drivable between a first operating condition at which it connects the first and third ends (200a, 200c) of said auxiliary connecting circuit (200) with each other, and a second operating condition at which it connects the third end (200c) of said auxiliary connecting circuit (200) with the second end (210b) of said first branch (210);
a third switch (250) drivable between a first operating condition at which it connects the second and fourth ends (200b, 200d) of said auxiliary connecting circuit (200) with each other and a second operating condition at which the fourth end (200d) of said auxiliary connecting circuit (200) is connected to the first end (220a) of said second branch (220);
a fourth switch (260) drivable between a first operating condition at which it connects the second and third ends (200b, 200c) of said auxiliary connecting circuit (200) and a second operating condition at which it connects the third end (200c) of said auxiliary connecting circuit (200) to the second end (220b) of said second branch (200).

31. An apparatus as claimed in claim 30, wherein at said first, second and third operating conditions and said first, second and third intermediate conditions of said connecting block (60), said first and fourth switches (230, 260) of said auxiliary connecting circuit (200) are in their first operating condition, said second and third switches (240, 250) of said auxiliary connecting circuit (200) being in their second operating condition.

32. An apparatus as claimed in claim 30 wherein at said first, second and third operating conditions and said first, second and third intermediate conditions of said connecting block (60), said first and fourth switches (230, 260) of said auxiliary connecting circuit (200) are in their second operating condition, said second and third switches (240, 250) of said auxiliary connecting circuit (200) being in their first operating condition.

33. An apparatus as claimed in claim 29, wherein said control unit (50) further comprises a processing block (51) operatively active on said first and second main switches (61, 62), on said main connecting circuit (100) and on said auxiliary connecting circuit (200) to control operation of same.

34. An apparatus as claimed in claim 20, wherein said autotransformer (11) has a plurality of auxiliary terminals (12), each associated with a respective switch (13), each of said switches (13) being drivable between a closed condition at which it connects the auxiliary terminal (12) associated therewith to the main connecting circuit (100) and an open condition at which said connection is not established.

35. An apparatus as claimed in claim 34, wherein said plurality of auxiliary terminals (12) is defined by a first group of auxiliary terminals (15) and a second group of auxiliary terminals (16), the auxiliary terminals of said first group (15) being connectable by means of the respective switches, with the third end (100c) of said main connecting circuit (100), the auxiliary terminals of said second group (16) being connectable, through the respective switches, with the second end (100b) of said main connecting circuit (100).

36. An apparatus as claimed in claim 20, wherein said autotransformer (11) further comprises an auxiliary winding (14) operatively coupled with said autotransformer (11), said autotransformer (11) and auxiliary winding (14) defining a second transformer (10).

37. An apparatus as claimed in claim 20 wherein the second winding (32) of said first transformer (30) is connected in series with the auxiliary winding (14) of said second transformer (10).

38. A process for power control, in particular for lighting installations, comprising the following steps:
arranging an autotransformer (11) susceptible of connection to a supply unit (20) to draw a predetermined voltage from said supply unit (20), and having a main terminal (303) and a predetermined number of auxiliary terminals (12a, 12b), said predetermined voltage being defined between said main terminal (303) and at least one of said auxiliary terminals (12a, 12b);
arranging a first transformer (30) having a first winding (31) associated with said autotransformer (11) and through which a control current (310) runs, and a second winding (32) operatively coupled with said first winding (31) and connectable to a load (40) to regulate power supply to the latter;
arranging a first resistor (111) and a second resistor (141);
connecting a first end (141a) of said second resistor (141) to a first end (31a) of said first winding (31);
connecting the first end (141a) of said second resistor to a second end (31b) of said first winding;
directly connecting the first and second ends (31a, 31b) of said first winding (31) to each other;
connecting the second end (31b) of said first winding (31) to the main terminal (303) of said autotransformer (11);
connecting a second end (141b) of said second resistor (141) to a first auxiliary terminal (12a) of said autotransformer (11);
interrupting the direct connection between the first and second ends (31a, 31b) of said first winding (31);
interrupting the connection between the first end (141a) of said second resistor (141) and the second end (31b) of said first winding (31);
directly connecting the first and second ends (141a, 141b) of said second resistor (141) to each other;
interrupting the connection between the second end (141b) of said second resistor (141) and the first auxiliary terminal (12a) of said autotransformer (11);
connecting a first end (111a) of said first resistor (111) with the first end (31a) of said first winding (31);
connecting a second end (111b) of said first resistor (111) to a second auxiliary terminal (12b) of said autotransformer (11);
interrupting the direct connection between the first and second ends (141a, 141b) of said second resistor (141);
directly connecting the first and second ends (111a, 111b) of said first resistor (111) with each other;
interrupting connection between the second end (111b) of said first resistor (111) and the second auxiliary terminal (12b) of said autotransformer (11).
